(19) United States
(12) Patent Application Publication
(10) Pub. No.: US 2008/0103817 A1
(43) Pub. Date: May 1, 2008

(54) PORTABLE MEMORY DEVICES AND SYSTEM AND METHOD FOR USING SAME IN PHARMACEUTICAL TRANSACTIONS

(76) Inventor: Edward H. Bohlke III, New York, NY (US)

Correspondence Address: SERIOUS USA, INC.;c/o TORYS LLP, SUITE 3000 , P.O.BOX 270, 79 WELLINGTON STREET WEST , TD CENTRE, TORONTO, ON, M5K 1N2, CA

(21) Appl. No.: 11/833,166

(22) Filed: Aug. 2, 2007

Related U.S. Application Data
(60) Provisional application No. 60/835,057, filed on Aug. 2, 2006.

(51) Int. Cl. G06Q 30/00; G06Q 50/00

(52) U.S. Cl. 705/2; 705/1; 705/14

(57) ABSTRACT

The present invention provides systems and methods for administering discount and sample redemption programs for prescription and/or non-prescription drugs and other products sold in a pharmacy, and for providing patient education information, through optical discs or other portable memory devices, whether optical or not.

### CROSS REFERENCE TO RELATED APPLICATIONS AND INCORPORATION BY REFERENCE

This application claims priority to U.S. Provisional Patent Application Ser. No. 60/835,057, entitled Portable Memory Devices and System and Method for Using Same in the Pharmaceutical Transactions and filed Aug. 2, 2006, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### REGULATORY NOTICE

This application contains material relating to the sale of medication and other pharmaceuticals and medical devices. The sale of medication, pharmaceuticals and medical devices is regulated, as for example by the United States Government, the various State governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any method or process proposed or discussed herein does or does not comply with any statute, law, regulation, or other legal requirement whatsoever, in any jurisdiction; nor should it be taken or construed as doing so.

### BACKGROUND

Pharmaceutical agents, such as pharmaceutical companies and manufacturers, or a third party performing services on their behalf, may develop support for a medication by offering redemption programs that allow a patient to receive a sample of a given medication. Such samples may be distributed through doctors, retailers (such as pharmacies) or through a pharmaceutical agent's own initiatives, such as direct mailing.

Once a medication is introduced to the market, pharmaceutical agents are interested in keeping their patients' loyalty to this medication. Thus, in addition to providing samples through redemption programs, pharmaceutical may participate in loyalty programs where patients are eligible for discounts for continued use of a given brand of medication.

Redemption and loyalty programs are not new to the U.S. market place and in the near future similar programs may be introduced in countries that do not currently have such programs. Regardless of whether such programs are already existing or may be introduced in the future, there exists a need for a more streamlined, interactive mechanism to administer these programs and to present them to patients such that these programs are easier to use for both pharmaceutical agents and patients alike.

In addition to introducing a medication to the market through redemption programs and to retaining and increasing a medication's market position through loyalty programs, pharmaceutical agents are constantly looking forward to future marketing and research and development efforts. Therefore, they are interested in obtaining feedback about who is using a medication and why. However, it is often difficult to obtain such feedback as patients are hesitant to spend time and energy completing and mailing surveys. Thus, there exists a need for a survey that can be completed quickly and without hassle, and/or that is presented in a way that would not only entice a patient to complete it but would also allow a patient to do so quickly and efficiently.

Patients are interested not only in obtaining medication in a cost-effective way, but also in obtaining readily available, relevant patient education information together with that medication, information that may save them hours of time trying to find answers on the Internet, or looking up terms in medical dictionaries, or trying to remember the dosage, schedule, or interaction instructions for their medications (especially when a patient uses multiple medications). Thus, there exists a need for readily available and preferably interactive patient education information to accompany a medication or a medical device, such as information about the usage of a medication or medical device, as well as information about a disease targeted by a medication or device, general health and prevention information, physical exercise appropriate to a patient in a given condition, etc.

### SUMMARY OF THE INVENTION

The present invention provides systems and methods for administering discount and sample redemption programs for prescription and/or non-prescription drugs, medical devices, and products sold in a pharmacy, and for providing patient education information, through optical discs or other portable memory devices, whether optical or not.

According to various embodiments of the invention, portable memory devices may be used as loyalty or discount “cards” for pharmaceutical discount programs at participating pharmacies. Portable memory devices according to such embodiments may comprise additional information recorded on or associated with value storage devices which confirm a user entitlements to rewards such as discounts for prescription and/or non-prescription products sold in participating pharmacies.

According to further embodiments of this invention, portable memory devices may be used as sample redemption “cards” for redeeming drug samples in clinical trials. Portable memory devices according to such embodiments comprise recorded thereon questionnaires from one or more drug companies, said questionnaires containing queries relevant to drug companies' research and development or marketing efforts. Alternatively, portable memory devices according to the invention may contain links connecting users to clinical trial or other websites which contain such questionnaires. Users complete the questionnaires and thereby register to receive a reward of free drug samples, or perhaps a medical device trial, which reward can be redeemed by presenting portable memory devices according to the invention to participating pharmacies, wherein said devices may comprise additional information recorded on or associated with, for example, value storage devices. Methods of distributing free drug samples according to the invention allow drug companies to gather information regarding the distribution of free drug samples, which information is useful in marketing and/or research and development efforts. It also allows pharmaceutical companies to track the number of samples distributed, by whom, and where.

Value storage devices according to the invention may include any one or all of the following: magnetic stripes, radio frequency identifiers (RFID), smart chips, memory chips, bar codes, unique user identification numbers, applications recorded on an optical disc or on other portable memory devices, unique codes as shown and described in U.S. 60/784,156, or any other means now known or later developed in the art for storing value-related information such as a user's balance, or entitlement to discounts or promotions, etc.

In various embodiments, portable memory devices of this invention also have recorded thereon, or contain weblinks to, patient education information, which may be interactive. Examples of patient education information include information about disease agents and states, and side-effects and proper usage of drugs; treatment programs; email or other electronic notifications to patients reminding them to take their medicine and/or refill prescriptions; marketing content; etc. Patient education information may be tailored to target a specific drug or drugs relevant to a particular patient and/or it may contain general health advice.

Preferably, user sessions with portable memory devices are monitored by tracking software, thus allowing pharmaceutical companies or any other interested parties to better tailor their research and development or marketing strategies.

In embodiments in which portable memory devices include optical discs, such optical discs may have non-round shapes and may be wallet-sized. Most preferably, such optical discs have these and other dimensions and shapes approximately corresponding to those of credit cards.

These and other embodiments of the invention are further discussed herein below.

### BRIEF DESCRIPTION OF THE DRAWINGS

The invention is illustrated in the figures of the accompanying drawings, which are meant to be exemplary and not limiting, in which like references are intended to refer to like or corresponding parts, and in which:

FIG. 1 is a schematic diagram of an embodiment of a system according to the invention;

FIG. 2 is a plan view of an embodiment of an optical card according to the invention;

FIG. 3 is a plan view of another embodiment of an optical card according to the invention;

FIG. 4 is a plan view of another embodiment of an optical card according to the invention;

FIG. 5 is a plan view of another embodiment of an optical card according to the invention;

FIG. 6 is a flow chart of an embodiment of a method according to the invention;

FIG. 7 is a flow chart of another embodiment of a method according to the invention.

### DETAILED DESCRIPTION OF THE INVENTION

References to “user computer”, as used herein are not limited to a user's home computer and include any optical card reader, including a CD or DVD player, and any computer into which a user can insert an optical disc according to the invention. References to “optical disc” as used herein include CDs, DVDs, or any other types of optical discs now known or later developed, including, for example, recordable, rewritable, and erasable CDs and DVDs in any format that is compatible with being read by an optical drive of any size, shape, configuration, type or format, now known or later developed. References to “optical card” include optical discs having a size and shape approximately that of an open loop card such as a credit card, and include rectangular cards and cards having at least one arcuate portion. References to a “portable memory device” as used herein include solid state technology, such as optical discs, memory sticks or cards, flash drives, Universal Serial Bus (USB)-compatible devices and other solid state technology now known or later developed in the art. References to a “portable memory device” as used herein include any device that can read from and/or write to a portable memory device, including a CD-ROM or DVD drive, a disk drive, an RFID transceiver, a computer processor, and a USB port. References to “value storage” devices as used herein include a magnetic stripe, a radio frequency identifier (RFID), a smart chip, a memory chip, a bar code, a unique user identification number, a unique code as shown and described in U.S. 60/784,156, an application recorded on an optical disc, a combination of all or any of the above, or any other means now known or later developed in the art for storing value-related information or financial data such as a user's balance, or entitlement to discounts or promotions, or redemption of samples, etc. References to “pharmacy computer” as used herein include any computer which is used at a reward redemption point according to this invention, such as at a pharmacy or in a doctor's office. “Pharmaceutical agent” as used herein refers to any pharmaceutical company, manufacturer or an agent or administrative company performing services on behalf of a pharmaceutical company or manufacturer. “Patient” and “user” are used herein interchangeably.

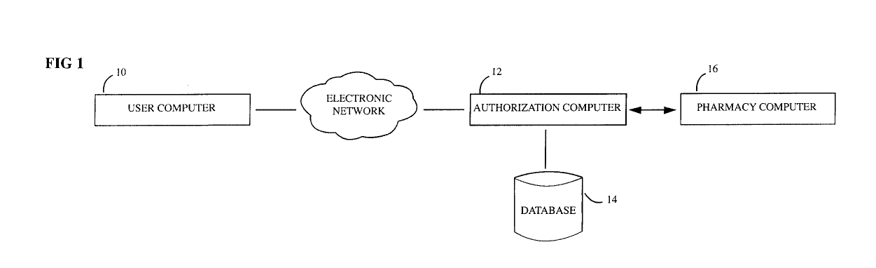

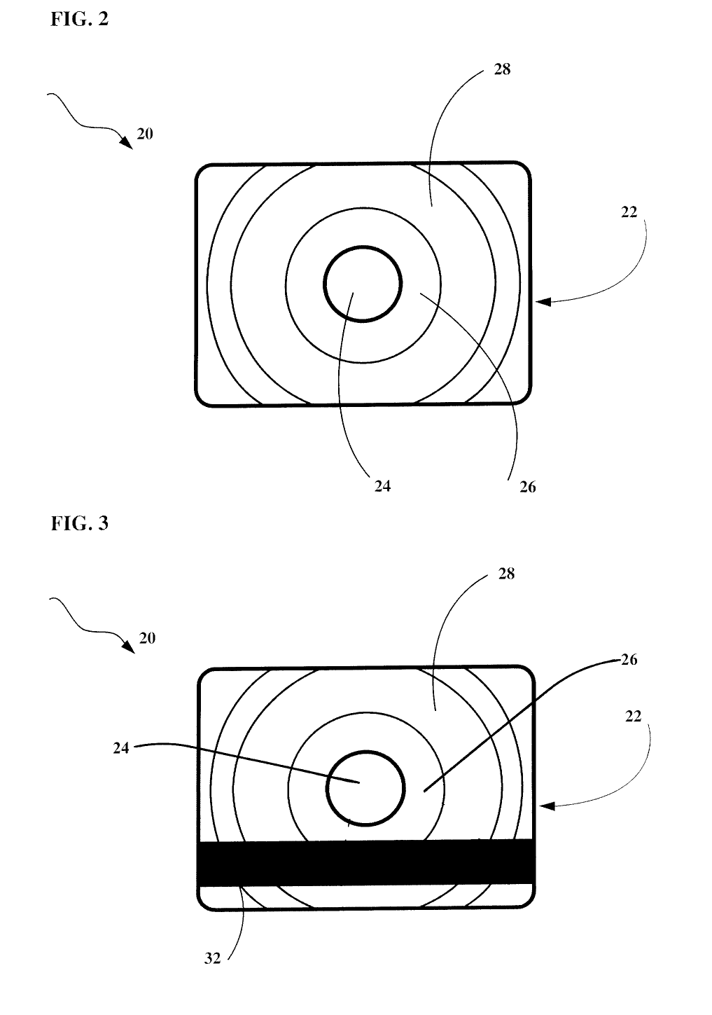

Referring to FIG. 1, an embodiment of a system according to this invention involves at least one user computer 10 in communication with a communications network, the user computer 10 having a drive or reader in which an optical disc can be inserted (or to which it can be connected) and read and/or a port into which a portable memory device can be inserted, whether through a USB-type or any other connection; at least one authorization computer 12, at least one authorization computer associated database 14; and at least one pharmacy computer 16. It is to be understood that in some embodiments of the present invention, for example as described below in reference to FIGS. 2-7, user computer 10 may be the same computer or party as pharmacy computer 16 or authorization computer 12, and pharmacy computer 16 may be the same computer or party as authorization computer 12. It will be apparent to those of skill in the art that such embodiments may involve corresponding variations on the systems, devices and methods illustrated in FIGS. 1-7, such as different network arrangements or requirements.

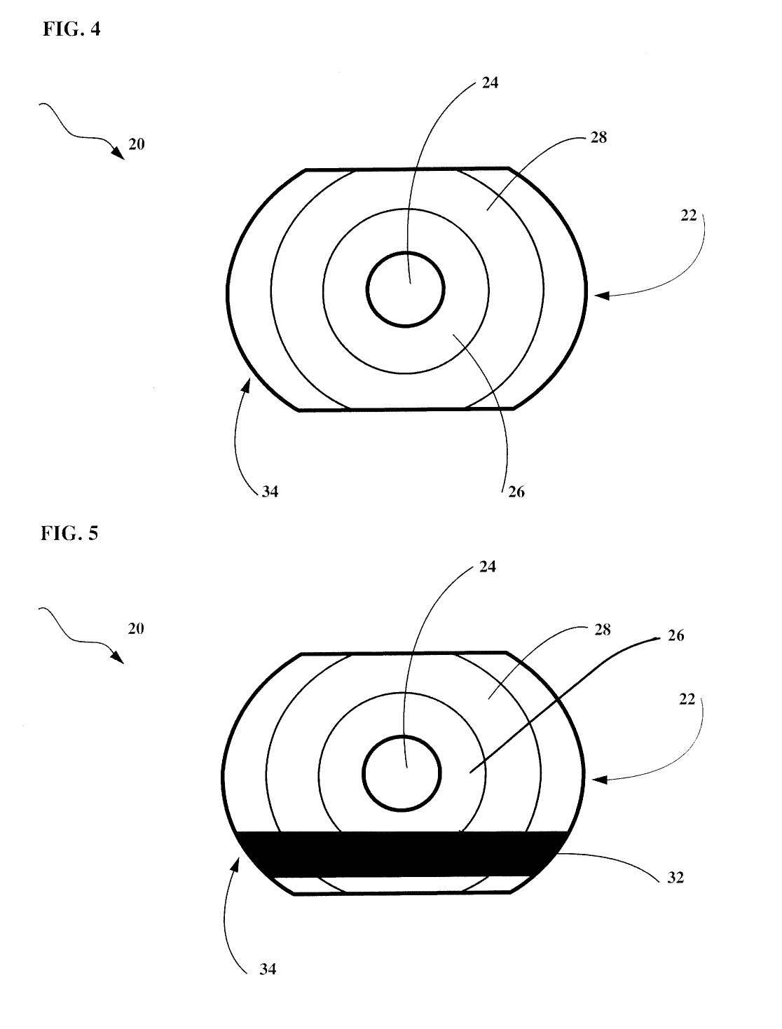

FIG. 2 shows an embodiment of an optical card 20. An optical card 20 of the present invention can be of any size, shape, configuration, type or format that is compatible with being read by an optical drive of any size, shape, configuration, type or format, now known or later developed. In some embodiments, the size of an optical card 20 is approximately the same as that of a credit card. In some embodiments, shown in FIGS. 2-3, an optical card 20 has a rectangular shape. In some embodiments, shown in FIGS. 4-5, an optical card 20 has rounded, or arcuate, edges 34. In various embodiments, an optical disc of the present invention may be of any size, such as, for example, having a diameter of 12 cm, 8 cm or anything in between, and may have a figurative, or suggestive, shape, such as a pill bottle, a pill, or a pharmaceutical company logo. The shapes and sizes presented herein are merely illustrative and it will be understood by those skilled in the art that many other shapes and sizes are compatible with an optical disc according to the invention.

Referring to FIG. 2, an optical card 20 is shown which comprises an optical disc 22 such as a CD, DVD, or any other optical disc now known or later developed, including, for example, recordable, rewritable, and erasable compact discs. In some embodiments optical disc 22 comprises a drive opening 24, which is bordered by a placement area 26. Placement area 26 may be an area on optical disc 22 that a user can touch that does not contain data—hence a user would not affect data in data area 28. Adjoining placement area 26 is data area 28 on which data can be written. An optical disc 22 may have dual signal (read) surfaces (that is, for example, may include data area(s) 28 on both sides) or may have one signal surface and one visual display surface having a visual label or other image attached or directly printed thereon by any means known in the art.

It will be understood by those skilled in the art that optical discs 22 of the invention do not need to have a drive opening 24 in order to be read by an optical drive. Therefore, the present invention encompasses embodiments wherein an optical disc does not have a drive opening 24 but is made at least in part of material compatible to being engaged by the spindles of an optical drive; or that has a three dimensional shape, including for example any indentations, plateaus, ridges, or troughs, protruding or extruding therefrom, that act to position and engage such a disc in an optical drive, thus allowing such disc to be read by such drive.

According to various embodiments of the invention, an optical disc 22 or another portable memory device has stored thereon or provides hyperlinks, shortcuts, URLs or other links to patient education content, whether multimedia or otherwise, whether interactive or otherwise, that provides patient education information. Examples of patient education information include information about diseases and disease agents that are relevant to the user's condition, information about side-effects and proper usage of drugs; treatment programs; interactive games and trivia quizzes to facilitate learning about a particular disease, or medication, or how to maintain a healthy lifestyle, etc.; marketing content from the pharmaceutical agent, advertising, links to the pharmaceutical agent's website and to other websites that provide useful information regarding specific diseases and other information relevant to the patient's condition; means for uploading and/or writing information from/to a pharmaceutical agent's website (and from/to other relevant websites if allowed by such websites) to an optical disc 22 such as updated healthcare information, or tracking information relating to medication that has been received or taken, or eligibility for discount programs etc; downloadable content such as nutrition tables; informative screen savers, etc. It will be apparent to those of skill in the art that the type and variety of patient education information that can be included is virtually endless. The patient education information may be tailored to target a specific drug or it may provide general information about leading a healthy lifestyle.

Optionally, an optical disc 22 or another portable memory device may have stored thereon one or more programs, written by any means known in the art, which load onto a user computer 10 and cause email or other electronic notifications to be sent to a user reminding him or her to take medicine and/or refill a prescription. Such electronic notifications can be sent to a user's mobile telephone or to a handheld device such as a blackberry, etc., or to any email or other address specified by a user.

Optionally, an optical disc 22 can be a recordable optical disc, allowing a user to record additional content, whether multimedia or otherwise, whether interactive or otherwise, chosen by a user, such as tracking, dosage or schedules for taking medication, or even non-health-related information such as songs, photographs, video clips or movies. An optical disc 22 may store large data files utilizing technology such as, for example, BluRay or any other technologies that accomplish a similar purpose and that is now known or later developed in the art. If using another portable memory device, a user also can record additional information thereon.

According to various embodiments of the invention, an optical card 20 or another portable memory device can be used to redeem a drug sample from a pharmacy such as, for example, when a user is participating in a clinical trial. According to such embodiments, optical disc 22 or another portable memory devices have at least one program stored thereon which is executed when said card 20 or device is inserted in an optical disc drive or plugged into an applicable port, respectively, such as through use of an auto-execute command. The at least one program may be written by any means known in the art and may comprise a questionnaires and, optionally, registration requests. Alternatively, an optical card 20 or another portable memory device can contain a web or other link connecting a user to a clinical trial and/or pharmaceutical agent website containing such questionnaire, and possibly additional relevant content and programming. A questionnaire may, for example, comprise questions that are relevant to a pharmaceutical agent for purposes such as research and development, marketing and/or tracking who redeems the free drug sample, who is the prescribing doctor, where the drug sample is redeemed, what specific condition it is prescribed for, and any other questions relevant to the pharmaceutical agent. Preferably, a questionnaire is a pre-requisite for the subsequent redemption of a prescribed free drug sample at a pharmacy. A registration screen can open at any point after optical disc 22 or another portable memory device is activated, preferably after a questionnaire is completed. Optionally, a registration request can be incorporated into the questionnaire. Completion of the registration may entitle a user to redemption of a reward such as a free drug sample. Such entitlement may be associated with a user (via their name for example) or with an optical card 20 or portable memory device. It is to be understood that any form of user response solicitation can replace or co-exist with a questionnaire. Exemplary forms of user response solicitations include informational or educational modules (such as regarding a medication or disease), a feedback module (such as relating to a user's experience with a medication), or a test module (such as determining whether a user has fully read and comprehended information presented to them). In various embodiments, a user may be prompted to provide substantive user input such as answering questions, or merely indicate that they have seen or read information presented to them.

FIG. 3 shows an embodiment of this invention where an optical card 20 or another portable memory device can be used as a loyalty card for prescription purchases and refills and/or for purchases of non-prescription products sold at a pharmacy. According to the illustrated embodiment, a magnetic stripe 32 includes information that is typically contained in magnetic stripes of traditional stored value or open loop cards or, alternatively, any information specified by a pharmaceutical agent, pharmacist, or any retailer of prescription and/or non-prescription drugs, regarding loyalty discounts and data. For example, discount information or programs may include the amount of discount to which a user may be entitled, how many separate times a user can apply a discount to a purchase, (e.g., the first three prescription refills are entitled to a 10% discount or the first three purchases of anything in a participating pharmacy are entitled to a 10% discount) or it may be a more complex program involving tiered discounts where the greater the purchase, the greater the discount, discounts when using a particular stored value card for paying for the transaction, or discounts offered together by more than one of the parties, etc. Any of such data may be read from, or written to, optical card 20. Magnetic stripe 32 can be placed either on the signal surface or the visual display surface of an optical card 20. FIG. 3 shows a magnetic stripe 32 at the bottom of an optical card 20, but where such stripes may be placed in any position on an optical card 20, preferably in a position corresponding to where a magnetic stripe is customarily placed on credit or stored value cards to facilitate reading of the stripe by magnetic stripe readers.

Alternatively, or in addition to, an optical disc loyalty card or another portable memory device loyalty “card” according to this invention can comprise any other value storage device, such as any one or all of the following: a magnetic stripe, an RFID, a smart chip, a memory chip, a bar code, a unique user identification number, an application recorded on an optical disc, or any other means now known or later developed in the art for storing value-related information, or financial data, such as a user's balance, or entitlement to discounts or promotions, etc.

According to other embodiments, an optical card 20 or another portable memory device used as a drug sample redemption “card” or as a loyalty “card” may comprise said optical disc 22 or a portable memory device that either does or does not have prerecorded patient education information or electronic notification or that has either patient education information or electronic notification. Preferably, an optical disc 22 or another portable memory device according to this embodiment is a recordable disc or device, respectively, allowing a user to record such content as a user deems desirable.

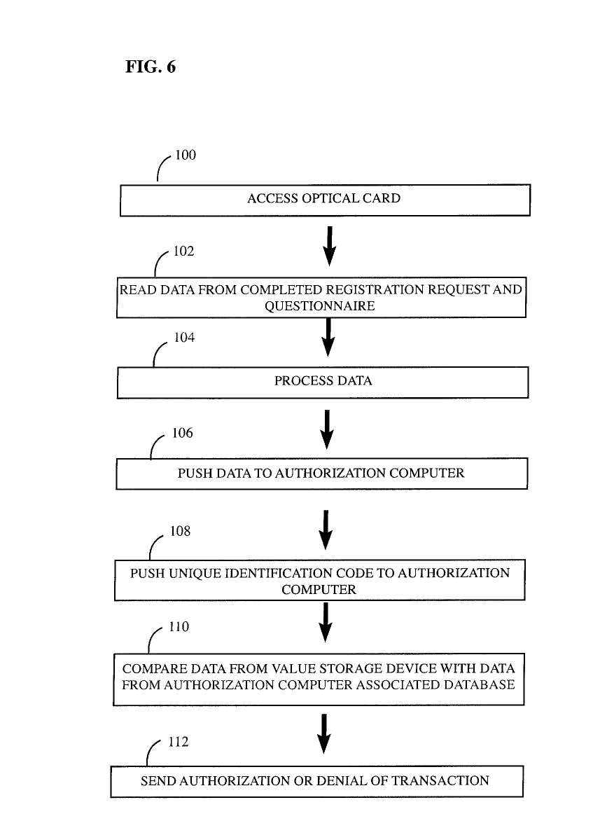

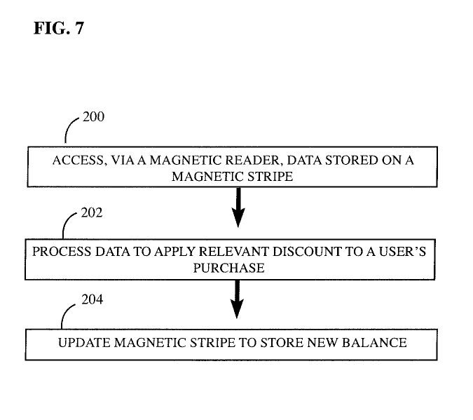

FIG. 6 is a flow chart illustrating a method of redeeming a drug sample from a pharmacy according to an embodiment of this invention. A user inserts an optical card 20 into an optical drive of a user computer 10. Optical card 20 may have a unique identification code printed on the visual surface thereof and/or it may have a unique identification code and/or other user information stored in a value storage device or otherwise stored on optical disc 22. At 100, a user computer 10 accesses optical card 20 and at least one program and/or execution command recorded on optical disc 22 and displays, or causes to be displayed, a questionnaire which a user is required to complete in order to redeem a free drug sample or other reward from a pharmacy, pharmaceutical agent or retailer, at the same or later time or date. Alternatively, optical disc 22 may contain a web or other link connecting a user to a drug trial or pharmaceutical website containing such questionnaire. The questionnaire can request, or otherwise solicit, any information that is of interest to a pharmaceutical agent, including, for example, why a user was prescribed the medication by his or her doctor, a user's symptoms, a user's lifestyle as it pertains to taking the medication, demographic information, etc. Preferably, before a user is allowed to exit the questionnaire or, alternatively, before a user leaves the drug trial/pharmaceutical website, a registration screen is displayed for a user to complete. At 102 a user computer 10 reads data from the completed questionnaire (and, optionally, registration form), at 104 a user computer 10 processes said data, and at 106 a user computer 10 pushes said data through an electronic network to an authorization computer 12 for processing. Said data is then stored in an authorization computer associated database 14. It is to be understood that the program recorded on optical disc 22 may cause or control 102, 104 and 106. Alternatively, a website containing a questionnaire may cause or control at least some of 102, 104 and 106. It is also to be understood that, as in FIG. 1, user computer 10 may be authorization computer 12. In such case, data may not need be pushed through an electronic network. In a further embodiment, a user may print out the questionnaire or user solicitation and provide it to an authorization service (which may include, for example, a point of entry kiosk having an attendant and authorization computer 12 which may be located at a pharmacy or pharmaceutical agent) or computer, at which point the information may be entered into authorization computer 12 and the method may proceed. While requiring further user initiative, such an embodiment may be beneficial, for example by obviating reliance on network communications.

Subsequently, a user can take optical card 20 to a participating pharmacy where, at 108, a pharmacist inputs into a pharmacy computer 16 the unique identification code printed on the visual side of optical card 20, which code is pushed to an authorization computer 12. Alternatively, if a unique identification code and/or user information is stored on a magnetic stripe, or an RFID, such information can be pushed to authorization computer 12 by swiping optical card 20 through a magnetic reader or an RFID reader, respectively. The unique identification code, data identifying optical card 20, may include any data identifying optical card 20 to authorization computer 12, such as an account number, a user number or patient number. Methods of pushing data to authorization computer 12 via an optical card comprising other value storage devices described herein will be apparent to those skilled in the art. Methods of pushing data to authorization computer 12 via another portable memory device are also apparent to those skilled in the art. At 110 authorization computer 12 compares data from a value storage device (or data associated with a unique identification code pushed from a pharmacy computer 16) with data from authorization computer associated database 14. At 112 authorization computer 12 sends a notification to pharmacy computer 16 that the transaction can been either approved or denied. At 114 data on authorization computer 12 is updated at the end of a transaction.

FIG. 7 is a flow chart illustrating an example of a method of using optical card 20 as a loyalty, discount, or any other stored value card for prescription and/or non-prescription purchases at a pharmacy, in an embodiment where discount information is contained in a magnetic stripe 32 disposed on optical disc 22. According to this embodiment, at 200 a magnetic stripe reader at a participating pharmacy accesses discount information or data, optionally related to a discount program, on a magnetic stripe 32 when optical card 20 is swiped through a magnetic stripe reader. At 202 data accessed from magnetic stripe 32 is processed by any means known in the art to apply a relevant discount to a user's purchase. At 204 data on magnetic stripe 32 is updated to store the new balance. It is to be understood that the method of FIG. 7 may be implemented using any means of storing data on optical card 20, including storing data optically, and may be implemented on any portable memory device.

A stored value optical card according to this invention may be activated by any number of alternative methods. For example, it may be automatically activated on line by means of an RFID or by means of activation data, such as a unique identification number, embedded on a readable side of optical disc 22 and read by a computer's optical drive (as shown and described in U.S. 60/784,156), or by any other means now known or later developed in the art. This may involve an auto-execute command that may optionally provide information to an activation service. Alternatively, a stored value optical card of this invention may be activated manually, either on-line, or through a telephone call or a mail-in form to an activation service. Alternatively, activation is not required and a user receives a stored value optical card (or another portable memory device) that is already activated and ready to use. Alternatively, a stored value or drug sample redemption card or device according to this invention may have a program stored thereon whereby a user can print out a coupon for the relevant discount, drug sample redemption, questionnaire or user solicitation etc., and take such coupon instead of an optical card or another portable memory device to a participating pharmacy, or mail such a coupon to a fulfillment center, etc.

According to various embodiments of the invention, a user's activities when viewing or interacting with patient education information stored on optical card 20 maybe monitored by any tracking software now known or later developed in the art, in order to assist an issuer of an optical card with marketing and/or research and development. Such tracking software may be located on optical card 20 or a tracking computer.

The embodiments disclosed above are for illustrative purposes only and are not meant to be exhaustive. It will be apparent to one of skill in the art that many alternative embodiments exist for using an optical card and/or another portable memory device according to this invention for redemption of drug samples or for making prescription and non-prescription purchases at a pharmacy.

A user may obtain an optical card or another portable memory device in accordance with the invention from many sources, including, for example, a user's physician, a participating pharmacy, a pharmaceutical agent, or through a promotional mailing from companies selling non-prescription products sold at a pharmacy (for example, vitamins, herbal supplements, hot water bottles, etc.).

It will be apparent to those of skill in the art that another portable memory device may be used instead of an optical disc in any of the foregoing embodiments of the products, methods, and systems of this invention.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims.

The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

All references cited herein are incorporated by reference.

What is claimed is:

1. An optical card configured for reading by an optical card reader, the optical card comprising stored computer-readable signals:
representing data identifying the optical card;
wherein the optical card is authorized for a reward when data identifying the optical card is received by an authorization service.

2. An optical card of claim 1, wherein the reward is selected from redemption and discount programs.

3. A portable memory device configured for reading by a portable memory device reader, the portable memory device comprising stored computer-readable signals:
representing data identifying the portable memory device;
adapted for causing a computer associated with the portable memory device reader to provide for output device signals useful for causing the output device to display an interface representing a questionnaire, and accept from an input device signals representing responses to the questionnaire;
wherein the portable memory device is authorized for a reward when the user input or data identifying the portable memory device is received by an authorization service.

4. A portable memory device configured for reading by a portable memory device reader, the portable memory device comprising stored computer-readable signals:
representing data identifying the portable memory device;
wherein the portable memory device further comprises data representing patient education information;
wherein the portable memory device is authorized for a reward when data identifying the portable memory device is received by an authorization service;
wherein the portable memory device further comprises stored computer-readable signals adapted for tracking whether a user has received medication or become eligible for a new discount program or level; and
wherein the portable memory device further comprises stored computer-readable signals adapted for causing a computer associated with the portable memory device reader to provide a reminder to a user of the portable memory device, wherein the reminder reminds a user to take medication, or fill or refill a prescription and wherein the reminder is sent to a user's email, mobile telephone, blackberry, or other handheld device.
